(19) United States
(12) Patent Application Publication
(10) Pub. No.: US 2010/0085488 A1
(43) Pub. Date: Apr. 8, 2010

(54) METHOD AND SYSTEM FOR WRITING A REFERENCE FRAME INTO A REFERENCE FRAME MEMORY

(75) Inventors: Shao-Yi Chien, Taipei (TW); Yi-Nung Liu, Taipei (TW)

Correspondence Address: OCCHIUTI ROHLICEK & TSAO, LLP, 10 FAWCETT STREET, CAMBRIDGE, MA, 02138, US

(73) Assignee: National Taiwan University, Taipei (TW)

(21) Appl. No.: 12/416,952

(22) Filed: Apr. 2, 2009

(30) Foreign Application Priority Data
Oct. 8, 2008 (TW) 097138701

(51) Int. Cl. H04N 9/64

(52) U.S. Cl. 348/714; 348/E09.037

(57) ABSTRACT

In a method and system for writing a reference frame having multiple pixels into a reference frame memory, the pixels of the reference frame are sampled to obtain a plurality of representative pixels. A multi-bit pixel value of each of the representative pixels is divided into a number (N) of bit sections, each corresponding to one of a number (N) of different bit significance levels, based on a bit depth, where N is associated with the bit depth. The bit sections of the pixel values of the representative pixels having the same bit significance level are arranged together to form a number (N) of bit depth planes each including the bit sections that have a corresponding one of the bit significance levels. The bit depth planes are stored in the reference frame memory.

### CROSS-REFERENCE TO RELATED APPLICATION

This application claims priority of Taiwanese Application No. 097138701, filed on Oct. 8, 2008.

### BACKGROUND OF THE INVENTION

1. Field of the Invention

The invention relates to a memory management technique, more particularly to a method and system for writing a reference frame into a reference frame memory.

2. Description of the Related Art

In a video coding system, intra-frame coding and inter-frame coding are used. The inter-frame coding includes predictive frame coding and bi-directional predictive frame coding. The predictive frame coding and the bi-directional predictive frame coding perform motion estimation based on a reference frame to generate a motion vector and residual signals, and subsequently, perform coding processing for compression of video data.

As the image resolution in video applications improves, the amount of computations required for motion estimation, an access bandwidth of an external memory, and the size of an internal memory increase, thereby increasing power consumption and costs.

At present, there are many fast algorithms for motion estimation, which are adapted to reduce the number of motion vector candidates. Although the aforesaid fast algorithms can reduce the amount of computations and the access bandwidth of the external memory, the size of the internal memory cannot be reduced.

### SUMMARY OF THE INVENTION

Therefore, an object of the present invention is to provide a method and system for writing a reference frame into a reference frame memory that can overcome the aforesaid drawback of the prior art.

According to one aspect of the present invention, there is provided a method of writing a reference frame into a reference frame memory. The reference frame includes a plurality of pixels. The method comprises the steps of:

a) sampling the pixels of the reference frame to obtain a plurality of representative pixels;

b) dividing, based on a bit depth, a multi-bit pixel value of each of the representative pixels into a number (N) of bit sections each corresponding to one of a number (N) of different bit significance levels, where N is associated with the bit depth;

c) arranging the bit sections of the pixel values of the representative pixels having the same bit significance level together to form a number (N) of bit depth planes each including the bit sections that have a corresponding one of the bit significance levels; and

d) storing the bit depth planes in the reference frame memory.

According to another aspect of the present invention, there is provided a system for writing a reference frame into a reference frame memory. The reference frame includes a plurality of pixels. The system comprises:

a sampling module for sampling the pixels of the reference frame to obtain a plurality of representative pixels;

a bit division module coupled to the sampling module and adapted for dividing, based on a bit depth, a multi-bit pixel value of each of the representative pixels into a number (N) of bit sections each corresponding to one of a number (N) of different bit significance levels, where N is associated with the bit depth;

an arrangement module coupled to the bit division module and operable to arrange the bit sections of the pixel values of the representative pixels having the same bit significance level together to form a number (N) of bit depth planes each including the bit sections that have a corresponding one of the bit significance levels; and

a writing module coupled to the arrangement module and adapted to be coupled to the reference frame memory for storing the bit depth planes from the arrangement module in the reference frame memory.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a video encoder employing the preferred embodiment of a system for writing a reference frame into a reference frame memory according to this invention;

FIG. 2 is a schematic circuit block diagram illustrating the preferred embodiment;

FIG. 3 is a schematic view illustrating a reference frame processed in the preferred embodiment;

FIG. 4 is a schematic diagram illustrating a macroblock of the reference frame;

FIG. 5 illustrates a multi-bit pixel value of a representative pixel of the reference frame divided into two bit sections having first and second bit significance levels according to the preferred embodiment;

FIG. 6 illustrates two bit depth planes formed according to the preferred embodiment;

FIG. 7 illustrates the bit depth planes stored in a reference frame memory according to the preferred embodiment; and

FIG. 8 is a flow chart illustrating a method of writing a reference frame into a reference frame memory performed by the system of the preferred embodiment.

### DETAILED DESCRIPTION OF THE PREFERRED EMBODIMENT

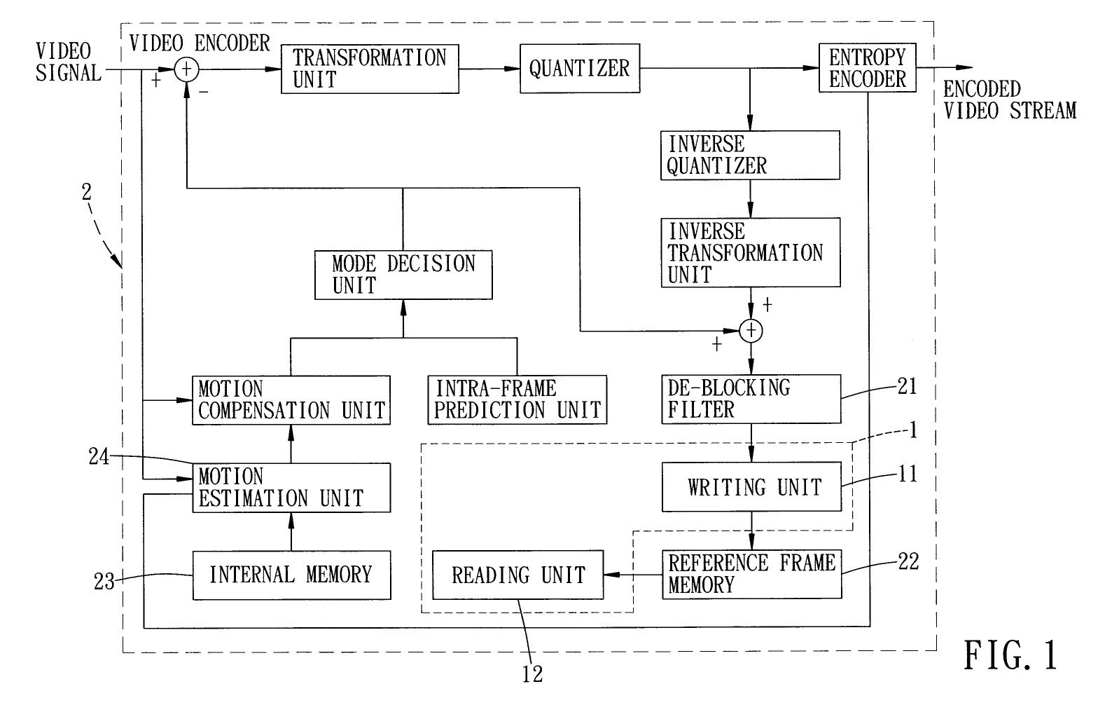

Referring to FIG. 1, a video encoder 2 employing the preferred embodiment of a system 1 according to the present invention is shown to include a motion estimation unit 24, and a de-blocking filter 21, an internal memory 23 and a reference frame memory 22 coupled to the system 1. The video encoder 2 performs compression and coding of an external video signal to output an encoded video stream corresponding to the external video signal. In this embodiment, the video encoder 2 conforms to an H.264/AVC standard. Since the feature of this invention does not reside in the specific configuration of the video encoder 2, which is known to those skilled in the art, details of the same are omitted herein for the sake of brevity.

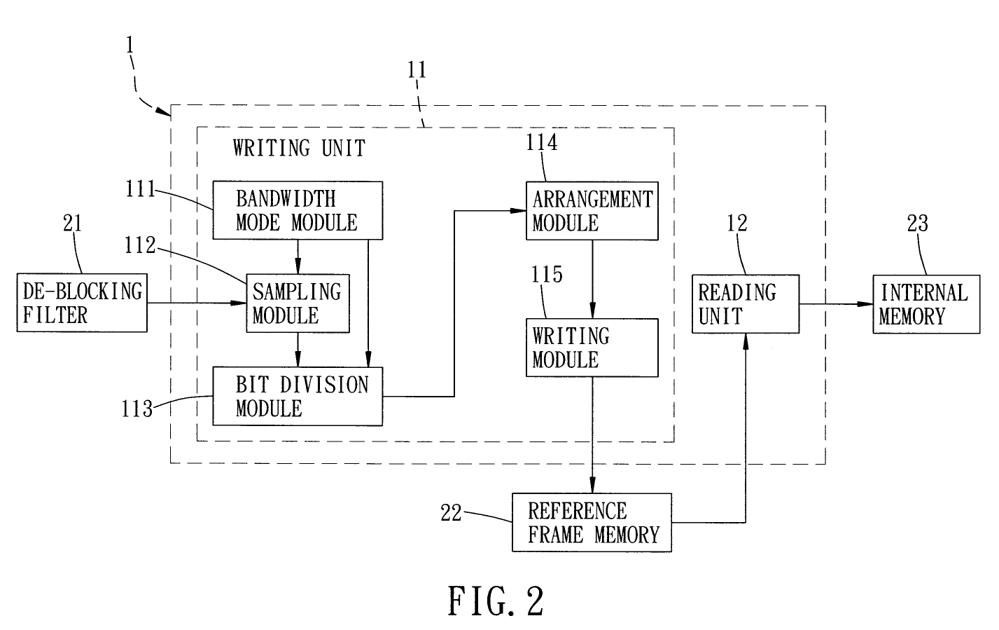

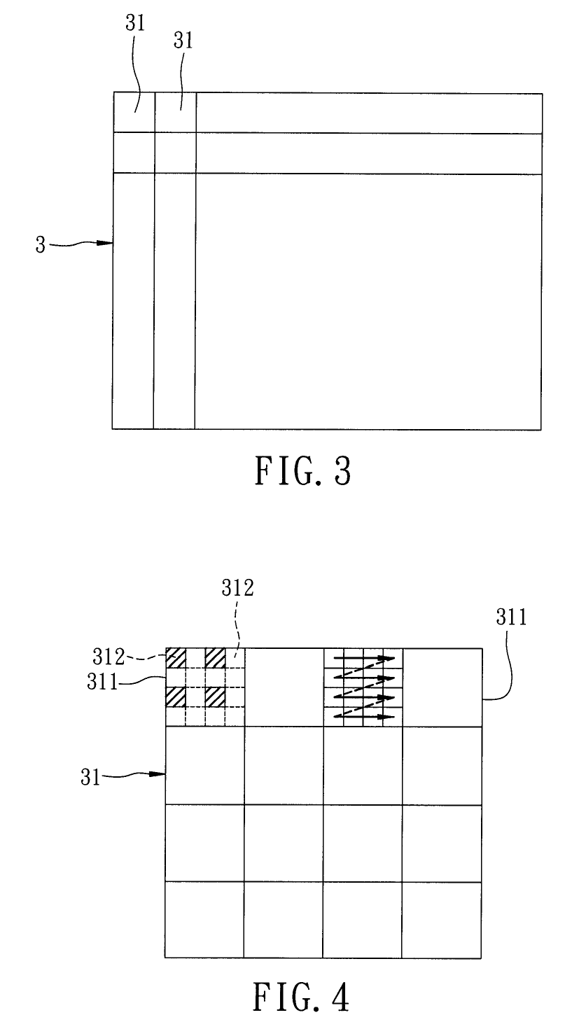

Referring further to FIGS. 2 and 3, the system 1 is shown to include a writing unit 11 and a reading unit 12.

The writing unit 11 is adapted for writing a reference frame 3 from the de-blocking filter 21 into the reference frame memory 22. In this embodiment, the reference frame 3 includes a plurality of macroblocks 31, as shown in FIG. 3. Referring to FIG. 4, each macroblock 31 includes a plurality of sub-blocks 311, such as 4×4 sub-blocks, each having a plurality of pixels 312, such as 4×4 pixels, wherein each pixel 312 has a multi-bit pixel value, such as an 8-bit pixel value. The writing unit 11 includes a bandwidth mode module 111, a sampling module 112, a bit division module 113, an arrangement module 114, and a writing module 115.

The bandwidth mode module 111 is operable to determine a bandwidth mode, and determines a bit depth and a sub-sampling rate based on the bandwidth mode, where the bit depth is a power of 2. In this embodiment, there are four different bandwidth modes, as shown in Table 1.

TABLE 1

| | | Sub-sampling |
|---|---|---|
| | Bit depth | rate |
| full bandwidth mode | 8 | 1 |
| half bandwidth | 8 | ½ |
| mode | 4 | 1 |
| quarter | 8 | ¼ |
| bandwidth mode | 4 | ½ |
| | 2 | 1 |
| one-eighth | 4 | ¼ |
| bandwidth mode | | |

In case where the bit depth and the sub-sampling rate are fixed, the bandwidth mode module 111 may be omitted in other embodiments of this invention.

The sampling module 112 is coupled to the bandwidth mode module 111, and is adapted to be coupled to the de-blocking filter 21 for receiving the reference frame 3 therefrom. The sampling module 112 samples the pixels 312 of the reference frame 3 at the sub-sampling rate of the bandwidth mode determined by the bandwidth mode module 111 to obtain a plurality of representative pixels 312. For example, when the bandwidth mode determined by the bandwidth mode module 111 is the one-eighth bandwidth mode, where the sub-sampling rate is ¼, the representative pixels 312 in each sub-block 311 are indicated by the shaded blocks in FIG. 4.

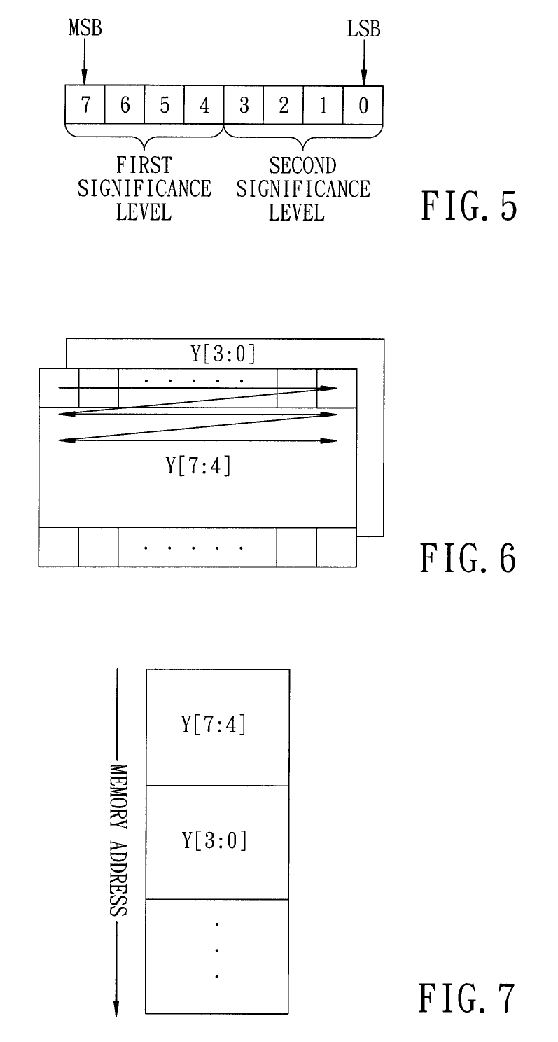

The bit division module 113 is coupled to the sampling module 112 and the bandwidth mode module 111, and is adapted for dividing, based on the bit depth determined by the bandwidth mode module 111, the multi-bit pixel value of each of the representative pixels 312 into a number (N) of bit sections each corresponding to one of a number (N) of different bit significance levels, where N is associated with the bit depth. According to the aforesaid example, when the bandwidth mode is the one-eighth bandwidth mode, where the bit depth is 4, if the multi-bit pixel value of each representative pixel 312 is an 8-bit pixel value, N is equal to 2 (=8/4). Therefore, for each representative pixel 312, the two bit sections of the 8-bit pixel value correspond to first and second significance levels, where one of the bit sections (bit[7:4]) corresponding to the first bit significance level includes the most significant bit (MSB) and the other one of the bit sections (bit[3:0]) corresponding to the second bit significance level includes the least significant bit (LSB), as shown in FIG. 5.

The arrangement module 114 is coupled to the bit division module 113, and is operable to arrange the bit sections of the pixel values of the representative pixels having the same bit significance level together to form a number (N) of bit depth planes each including the bit sections that have a corresponding one of the bit significance levels. In this embodiment, for each of the bit depth planes, the arrangement module 114 arranges the bit sections of the pixel values of the representative pixels 312 sampled by the sampling module 112 in the same sub-block 311 together in a line scan order indicated by the arrows in FIG. 4, and the arrangement module 14 arranges the bit sections of the pixel values of the representative pixels 312 sampled by the sampling module 112 in the same macroblock 31 together. According to the aforesaid example, as shown in FIG. 6, two bit depth planes (Y[7:4], Y[3:0]) are formed by the arrangement module 114.

The writing module 115 is coupled to the arrangement module 114, and is adapted to be coupled to the reference frame memory 22 for storing the bit depth planes from the arrangement module 114 in the reference frame memory 22. It is noted that, according to the aforesaid example, the bit depth plane (Y[7:4]) corresponding to the first bit significance level is stored in a lower-valued address space in the reference frame memory 22, and the bit depth plane (Y[3:0]) corresponding to the second bit significance level is stored in a higher-valued address space in the reference frame memory 22, as shown in FIG. 7.

The reading unit 12 is adapted to be coupled between the reference frame memory 22 and the internal memory 23 for reading a plurality of the bit sections in a specific one of the bit depth planes, such as the bit sections of a specific one of the macroblocks 31, or the bit sections corresponding to a search window, from the reference frame memory 22 during motion estimation. The reading unit 12 rearranges the bit sections read thereby and stores the rearranged bit sections in the internal memory 23 for subsequent use by the motion estimation unit 24.

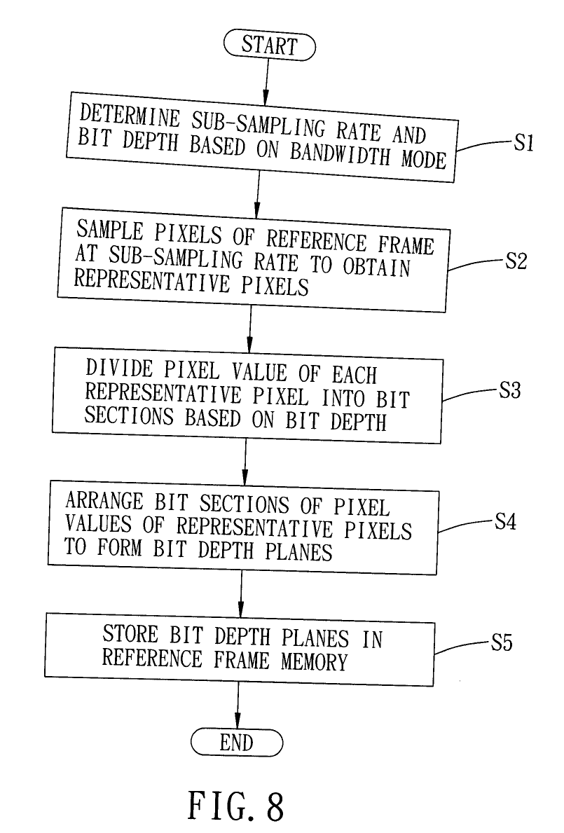

FIG. 8 is a flow chart illustrating a method of writing the reference frame 3 into the reference frame memory 22 performed by the system 1 of the preferred embodiment.

In step S1, the bandwidth mode module 111 is operable to determine the bandwidth mode, and determines the sub-sampling rate and the bit depth based on the bandwidth mode.

In step S2, the sampling module 112 samples the pixels 312 of the reference frame 3 at the sub-sampling rate to obtain the representative pixels 312.

In step S3, the bit division module 113 divides, based on the bit depth, the multi-bit pixel value of each representative pixel 312 into the number (N) of the bit sections each corresponding to one of the number (N) of the different bit significance levels.

In step S4, the arrangement module 114 arranges the bit sections of the representative pixels 312 having the same bit significance level together to form the number (N) of the bit depth planes each including the bit sections that have the corresponding one of the bit significance levels.

In step S5, the writing module 115 stores the bit depth planes in the reference frame memory 22.

In use, when the motion estimation unit 24 of the video encoder 2 is operated based on fast algorithms, such as a three-step search algorithm, a diamond search algorithm, two-dimension log algorithm, etc., the reading unit 12 reads from the reference frame memory 22 the bit sections, which correspond to a larger search window, of a specific one of the bit depth planes, such as the bit depth plane (Y[7:4]) corresponding to the one-eighth bandwidth mode in the aforesaid example during initial motion estimation, and reads the bit sections, which correspond to a smaller search window, of one of the bit depth planes corresponding to the full bandwidth mode during advanced motion estimation. As a result, since the amount of data read by the reading unit 12 and stored in the internal memory 23 is reduced, the required size of the internal memory 22 suitable for the motion estimation module 24 can be reduced, thereby reducing costs.

The following are some of the advantages attributed to the system 1 of the present invention:

1. Due to the utilization of the bit depth planes, the access bandwidth of the reference frame memory 22 is reduced and the required size of the internal memory 23 for motion estimation is reduced, thereby reducing power consumption and costs.

2. The system 1 is adapted for arranging access data to the reference frame memory 22. Therefore, the system 1 of the present invention can be easily applied to conventional video encoders.

3. Since the system 1 can be implemented without complicated control procedures, the system 1 of the present invention can be easily realized as a system on a chip (SOC).

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method of writing a reference frame into a reference frame memory, the reference frame including a plurality of pixels, said method comprising the steps of:
a) sampling the pixels of the reference frame to obtain a plurality of representative pixels;
b) dividing, based on a bit depth, a multi-bit pixel value of each of the representative pixels into a number (N) of bit sections each corresponding to one of a number (N) of different bit significance levels, where N is associated with the bit depth;
c) arranging the bit sections of the pixel values of the representative pixels having the same bit significance level together to form a number (N) of bit depth planes each including the bit sections that have a corresponding one of the bit significance levels; and
d) storing the bit depth planes in the reference frame memory.

2. The method as claimed in claim 1, the reference frame including a plurality of macroblocks each including a plurality of sub-blocks, each of the sub-blocks having a plurality of the pixels, wherein, in step c), for each of the bit depth planes, the bit sections of the pixel values of the representative pixels in the same sub-block are arranged together.

3. The method as claimed in claim 2, wherein, for each of the bit depth planes, the bit sections of the pixel values of the representative pixels in the same sub-block are arranged in a line scan order.

4. The method as claimed in claim 2, wherein, in step c), for each of the bit depth planes, the bit sections of the pixel values of the representative pixels in the same macroblock are arranged together.

5. The method as claimed in claim 1, further comprising, prior to step a), the step of determining the bit depth and a sub-sampling rate at which the pixels of the reference frame are sampled based on a bandwidth mode.

6. The method as claimed in claim 1, wherein the bit depth is a power of 2.

7. A system for writing a reference frame into a reference frame memory, the reference frame including a plurality of pixels, said system comprising:
a sampling module for sampling the pixels of the reference frame to obtain a plurality of representative pixels;
a bit division module coupled to said sampling module and adapted for dividing, based on a bit depth, a multi-bit pixel value of each of the representative pixels into a number (N) of bit sections each corresponding to one of a number (N) of different bit significance levels, where N is associated with the bit depth;
an arrangement module coupled to said bit division module and operable to arrange the bit sections of the pixel values of the representative pixels having the same bit significance level together to form a number (N) of bit depth planes each including the bit sections that have a corresponding one of the bit significance levels; and
a writing module coupled to said arrangement module and adapted to be coupled to the reference frame memory for storing said bit depth planes from said arrangement module in the reference frame memory.

8. The system as claimed in claim 7, the reference frame including a plurality of macroblocks each including a plurality of sub-blocks, each of the sub-blocks having a plurality of the pixels, wherein, for each of said bit depth planes, said arrangement module arranges the bit sections of the pixel values of the representative pixels sampled by said sampling module in the same sub-block together.

9. The system as claimed in claim 8, wherein, for each of said bit depth planes, said arrangement module arranges the bit sections of the pixel values of the representative pixels in the same sub-block in a line scan order.

10. The system as claimed in claim 8, wherein, for each of said bit depth planes, said arrangement module arranges the bit sections of the pixel values of the representative pixels sampled by said sampling module in the same macroblock together.

11. The system as claimed in claim 7, further comprising a bandwidth mode module coupled to said sampling module and said bit division module, and operable to determine a bandwidth mode corresponding to the bit depth and a sub-sampling rate at which said sampling module samples the pixels of the reference frame.

12. The system as claimed in claim 7, wherein the bit depth is a power of 2.
